(19) United States
(12) Patent Application Publication
(10) Pub. No.: US 2026/0220568 A1
(43) Pub. Date: Jul. 30, 2026

(54) SYSTEM AND METHOD FOR SCHEDULING WORK SCHEDULE

(71) Applicant: LITE-ON TECHNOLOGY CORPORATION, Taipei (TW)

(72) Inventors: Po-Feng Lin, Taipei (TW); Hua-Wei Huang, Taipei (TW)

(21) Appl. No.: 19/435,840

(22) Filed: Dec. 30, 2025

Related U.S. Application Data
(60) Provisional application No. 63/749,025, filed on Jan. 24, 2025.

(30) Foreign Application Priority Data
Nov. 5, 2025 (CN) 202511605869.3

(51) Int. Cl. G06Q 10/0631; G06Q 10/20

(52) U.S. Cl. CPC G06Q 10/063116; G06Q 10/20

(57) ABSTRACT

An aspect of the present disclosure features a system for scheduling a work schedule. The system includes a data loading module for loading work data related to the work schedule. The system also includes a calculation module communicatively connected to the data loading module for generating a work order sequence based on the work data. The system also includes a route planning module communicatively connected to the calculation module for generating route data based on the work order sequence. The system also includes a location determination module communicatively connected to the route planning module for determining whether the work schedule is completed based on a movement information of a vehicle and the route data. If it is determined that the work schedule has been completed, an end time and an end position of the vehicle are recorded.

This application claims the benefit of U.S. provisional application Ser. No. 63/749,025, filed Jan. 24, 2025, and the benefit of China application serial No. 202511605869.3, filed Nov. 5, 2025, subject matters of which are incorporated herein by reference.

### TECHNICAL FIELD

The disclosure relates in general to techniques for scheduling work schedule, and more particularly, to methods for scheduling work schedule used in maintenance tasks.

### BACKGROUND

In specific application scenarios, such as street light or charging pile maintenance, maintenance workers are typically required to report the actual maintenance routes to ensure transparency and traceability of the work schedule. For this purpose, Global Positioning System (GPS) technology can be used to collect GPS data on the movement of maintenance workers. However, relying solely on worker maintenance route reports lacks a dynamic adjustment mechanism, failing to optimize movement costs and work time. Furthermore, GPS records can be affected by drift points or anomalies, reducing the accuracy of route assessments, such as leading to inaccurate determination of the start and end points of a task. Therefore, there is a need for techniques that can calculate dynamic parameters such as speed changes and total travel time while processing GPS data for maintenance work routes.

### SUMMARY

The first aspect of the present disclosure features a system for scheduling work schedule. The system include a data loading module configured to load work data related to the work schedule. The system also includes a calculation module communicatively coupled to the data loading module to generate a work order sequence based on the work data. The system also includes a route planning module communicatively coupled to the calculation module to generate route data based on the work order sequence. The system also includes a location determination module communicatively coupled to the route planning module to determine whether the work schedule is completed based on a movement information of a vehicle and the route data. If it is determined that the work schedule has been completed, an end time and an end position of the vehicle are recorded; or If it is determined that the work schedule is not completed, continues to determine whether the work schedule is completed based on the movement information and the route data. The system also includes an output module, communicatively coupled to the location determination module to output the movement information, the end time and the end position of the vehicle.

The second aspect of the present disclosure features a method for scheduling work schedule, executed by a computing device. The method includes loading work data related to the work schedule. The method also includes generating a work order sequence based on the work data. The method also includes generating route data based on the work order sequence. The method also includes detecting a movement information of a vehicle. The method also includes determining whether the work schedule is completed based on the movement information and the route data. If it is determined that the work schedule has been completed, an end time and an end position of the vehicle are recorded; or if it is determined that the work schedule is not completed, continues to determine whether the work schedule is completed based on a movement information and the route data. The method also includes outputting the movement information, the end time and the end position of the vehicle.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram illustrating a system for scheduling work schedule, according to some implementations of the present application.

FIG. 2 is a flowchart illustrating procedure for scheduling work schedule, according to some implementations of the present application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

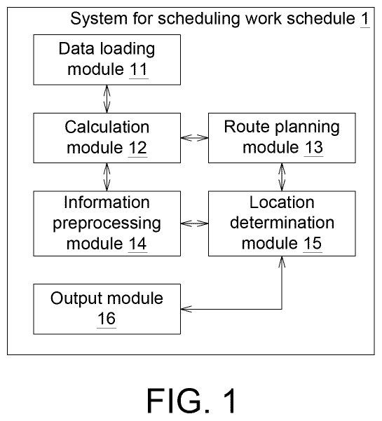

FIG. 1 is a block diagram illustrating a system 1 for scheduling work schedule, according to some implementations of the present application.

The system 1 for scheduling work schedule provided according to implementations of the present disclosure can be mainly applied to maintenance scenarios of infrastructure such as streetlights and charging piles. It uses the trajectory data of GPS movement information of vehicles used for maintenance and analyzes it with relevant models to accurately and automatically record maintenance routes for planning or outputting complete work schedules.

The system 1 for scheduling work schedule includes a data loading module 11, a calculation module 12, a route planning module 13, an information preprocessing module 14, a location determination module 15, and an output module 16. The data loading module 11 is communicatively coupled to the calculation module 12, the calculation module 12 is coupled to the route planning module 13 and the information preprocessing module 14, the location determination module 15 is coupled to the route planning module 13 and the information preprocessing module 14, and the output module 16 is coupled to the location determination module 15. The data loading module 11 is used to load work data related to the work schedule. The work data may include multiple work orders, and the corresponding work location, priority, and remaining maintenance time for each work order.

Specifically, the system 1 for scheduling work schedule can be built on the same (or different) servers (such as general-purpose servers, file servers, storage unit servers, etc.) and computers (such as personal computers, laptops, tablets, etc.) and other electronic devices with appropriate computing mechanisms. The modules in the system 1 for scheduling work schedule can be software, hardware or firmware. If it is hardware, it can be a processing unit, processor, computer or server with data processing and computing capabilities. If it is software or firmware, it can include instructions executable by the processing unit, processor, computer or server, and can be installed on the same hardware device or distributed on different multiple hardware devices. Furthermore, the system 1 for scheduling work schedule includes a hard disk (such as a mechanical hard disk, a solid-state hard disk, etc.), memory, other storage devices, or a combination of such devices.

The calculation module 12 is used to generate a work order sequence based on the aforementioned work data, and can dynamically adjust the work order sequence. Specifically, the importance of each work order can be evaluated based on its priority score to ensure that high-priority tasks can be completed in a timely manner. At the same time, the most suitable dispatch sequence is calculated by considering parameters such as comprehensive fault level, waiting time, and customer importance, and a weight adjustment mechanism is used to automatically adapt to different work needs, and there are no limitations thereto.

The route planning module 13 is used to generate route data based on the aforementioned work order sequence. Specifically, the route planning module 13 calculates and selects the optimal maintenance sequence (or maintenance route) based on the priority score of each work order and the distance between the corresponding work location of each work order. The route planning module 13 may, for example, apply a greedy algorithm to generate preliminary route data to ensure that the travel time of the vehicles used for maintenance is minimized as much as possible and to improve the efficiency of the trip. In some implementations, the route planning module 13 selects a work location of a work order with the highest priority score as the first target point based on the work order sequence, and then calculates multiple next target points sequentially based on the distance between the current position of the maintenance vehicle and work locations of uncompleted work order, as well as the priority scores of the uncompleted work orders. The route data is generated based on the first target point and the multiple next target points. When the status of a work order changes, such as when a change order is inserted during the schedule, the route planning module 13 can update and generate new route data in real time by working in conjunction with the aforementioned data loading module 11 and calculation module 12, thereby adjusting the work route accordingly.

The information preprocessing module 14 can be used to detect movement information of vehicle and preprocess and filter anomalies in the GPS data in the movement information. Specifically, the Haversine formula can be used to calculate the distance between each working location to ensure that the movement trajectory of the vehicle used for maintenance is reasonable, and a speed threshold can be used to filter out abnormal data points to ensure recording accuracy, automatically ignore GPS drift points, and improve the accuracy of route analysis.

The location determination module 15 can be used to determine whether the work schedule has been completed based on the movement information and the route data. When it is determined that the work schedule has been completed, an end time and an end position of the vehicle are recorded. In addition, the location determination module 15 can record the timestamp of the vehicle arriving at the work location of each work order based on GPS coordinates of the vehicle and the work location of each work order. Combined with the aforementioned information, automated start and end point detection can be achieved. Through algorithms, the location determination module 15 can automatically identify the start point and end point of the vehicle used for maintenance during the work schedule, improving the accuracy and reliability of work schedule data recording. The start point of the movement can be determined, for example, by automatically recording the start of the schedule when the vehicle used for maintenance moves more than 200 meters and at a speed exceeding 50 km/h, without requiring manual input. The end point of the movement can be determined, for example, by automatically determining the end of the schedule when the vehicle used for maintenance returns to a specific location (such as the company) within 50 meters and the interval between this return and the previous recording point exceeds one hour.

The output module 16 can be used to output travel information completed by the vehicle for maintenance, including the movement information, the end time, and the end position. By outputting the completed travel information, maintenance schedule of the vehicle for maintenance can be made transparent and management efficiency can be improved.

The techniques for scheduling work schedule provided according to implementations of the present disclosure will be described in detail as follows. The input parameters input into the data loading module 11 include the number of accepted work orders (accepted_jobs), the work location (job_location), priority (higher values indicate greater importance), and remaining repair time (repair_time) of each work order. The geographic information parameters used and/or calculated by the calculation module 12, route planning module 13, information preprocessing module 14, or location determination module 15 may include the path distance between work locations (represented by a distance matrix (distance_matrix) calculated from GPS data), anomalies (GPS data threshold (max_speed_threshold)), and start/end point determination ranges (such as start point radius (start_point_radius), end point radius (end_point_radius), start point speed (start_point_speed), and end point speed (end_point_speed)).

Specifically, the calculation module 12 can use the GPS coordinates of each work location to calculate the distance matrix (distance_matrix) between the work locations corresponding to work orders, and can use the Haversine algorithm or map API (Application Programming Interface) to perform distance calculation.

Next, the calculation module 12 can calculate the priority score of each work order based on the priority (Priority) and remaining repair time (Repair Time) of each work order. The priority score is: Score=α×Priority−β×Repair Time, wherein α and β are weighting coefficients used to adjust the proportion of the influence of priority and remaining time.

Priority (Priority) indicates the urgency level of a work order, and is typically determined by the following factors (indicators): severity (Severity), waiting time (Waiting Time), customer importance (Customer Importance), and service level agreement (SLA). Severity can be, for example, ranked from 1 to 5, with 5 being the most severe. Waiting time can be, for example, the time a customer waits for repairs, measured in hours. Customer importance can be, for example, ranked from 1 to 5, with 5 being the most important. Service level agreement (SLA) can be, for example, ranked from 1 to 5, with 5 being the highest level of restriction.

The level of priority is usually set from 1 to 5 (5 being the highest), and can be calculated by weighted summation, as shown in the following equation (1):

$$Priority = w 1 \times Severity + w 2 \times Waiting time + w 3 \times Customer Importance + w 4 \times SLA \qquad ( 1 )$$

Wherein w1~w4 are weighting coefficients (which can be adjusted according to maintenance work requirements). Each indicator needs to be standardized so that the final priority level falls between 1 and 5.

In one calculation example of priority, the values of the factors (indicators) for a work order can be assumed to be as follows: Severity=5 (highest fault level), Waiting Time=8 hours, Customer Importance=3 (normal customer), and SLA Penalty=2 (medium). The weights are set as w1=2.0 (most important fault level), w2=1.5, w3=1.0, and w4=1.2. According to the above equation (1), we can obtain:

$${Priority}^{′} = 2. \times 5 + 1.5 \times 8 + 1. \times 3 + 1.2 \times 2 = 10 + 12 + 3 + 2.4 = 27.4$$

Then, through standardization:

$$Priority = \frac{27.4}{maximum value} \times 5 ,$$

wherein the maximum value is calculated as: maximum fault level×w1+maximum waiting time for the day×w2+maximum customer importance×w3+maximum SLA Penalty×w4.

The remaining repair time represents the remaining repair time for the work order. When the system creates a work order, it will automatically generate a latest time that the repair must be completed, which is usually 72 hours (3 days). The remaining repair time indicates how much time is left before the latest time that the repair must be completed.

In one embodiment, the weighting coefficients α and β can be calculated using a data-driven approach, for example, based on historical data, such as the example data in TABLE I below:

TABLE I

| ID of | | Remaining | |
|---|---|---|---|
| work | | repair time | Actual completion |
| order | Priority | (hour) | sequence |
| 102 | 4 | 1 | 1 |
| 101 | 5 | 2 | 2 |
| 104 | 2 | 0.5 | 3 |
| 103 | 3 | 1.5 | 4 |

First, the calculation module 12 or through other calculation software (such as Matlab) establishes a regression model to find α and β. The regression equation can be set as shown in the following equation (2):

$$\frac{1}{Actual completion sequence} = α \cdot Priority - β \cdot Repair Time \qquad ( 2 )$$

Next, the data in the above TABLE I is converted into the following TABLE II:

TABLE II

| ID of work order | Priority | Remaining repair time (hour) | $\frac{1}{Actual completion sequence}$ |
|---|---|---|---|
| 102 | 4 | 1 | 1.000 |
| 101 | 5 | 2 | 0.500 |
| 104 | 2 | 0.5 | 0.333 |
| 103 | 3 | 1.5 | 0.250 |

Then, based on the above TABLE II, an equation is established as follows:

$$\{ \begin{matrix}1. = 4 α - 1 β \\ 0.5 = 5 α - 2 β \\ 0.333 = 2 α - 0.5 β \\ 0.25 = 3 α - 1.5 β\end{matrix}$$

Next, the Least Squares Method is used to find approximate solutions for α and β:

$$Assuming AX = B$$

$$A = [ \begin{matrix}4 & - 1 \\ 5 & - 2 \\ 2 & - 0.5 \\ 3 & - 1.5\end{matrix} ]$$

$$x = [ \begin{matrix}α \\ β\end{matrix} ]$$

$$B = [ \begin{matrix}1. \\ 0.5 \\ 0.333 \\ 0.25\end{matrix} ]$$

Standard formula for least multiplication is:

$$X = {( {A}^{T} A )}^{- 1} {A}^{T} B$$

Let A^{T} be the transformation matrix of A, and (A^{T}A)⁻¹ be the inverse matrix of (A^{T}A)

$${A}^{T} = [ \begin{matrix}4 & 5 & 2 & 3 \\ - 1 & - 2 & - 0.5 & - 1.5\end{matrix} ]$$

$${A}^{T} A = [ \begin{matrix}4 & 5 & 2 & 3 \\ - 1 & - 2 & - 0.5 & - 1.5\end{matrix} ] \cdot [ \begin{matrix}4 & - 1 \\ 5 & - 2 \\ 2 & - 0.5 \\ 3 & - 1.5\end{matrix} ] = [ \begin{matrix}54 & - 19.5 \\ - 19.5 & 7.5\end{matrix} ]$$

$${A}^{T} B = [ \begin{matrix}4 & 5 & 2 & 3 \\ - 1 & - 2 & - 0.5 & - 1.5\end{matrix} ] \cdot [ \begin{matrix}1. \\ 0.5 \\ 0.333 \\ 0.25\end{matrix} ] = [ \begin{matrix}7.916 \\ - 2.5415\end{matrix} ]$$

$${( {A}^{T} A )}^{- 1} = \frac{1}{det ( {A}^{T} A )} [ \begin{matrix}7.5 & 19.5 \\ 19.5 & 54\end{matrix} ]$$

$$det ( {A}^{T} A ) = ( 54 \times 7.5 ) - ( - 19.5 \times - 19.5 ) = 24.75$$

$${( {A}^{T} A )}^{- 1} = \frac{1}{24.75} [ \begin{matrix}7.5 & 19.5 \\ 19.5 & 54\end{matrix} ] = [ \begin{matrix}0.303 & 0.788 \\ 0.788 & 2.182\end{matrix} ]$$

$$Substitute X = {( {A}^{T} A )}^{- 1} {A}^{T} B$$

$$X = [ \begin{matrix}0.303 & 0.788 \\ 0.788 & 2.182\end{matrix} ] [ \begin{matrix}7.916 \\ - 2.5415\end{matrix} ] = [ \begin{matrix}0.396 \\ 0.692\end{matrix} ]$$

Then it can be concluded that α=0.396 [symbol] β≈0.692

For the route data generated by the route planning module 13, a preliminary route can be specifically established in the following way. First, set the start point of the route (such as the location of the company). Next, sort the work orders according to their priority scores and select the work order with the highest priority score as the first target point. Calculate the distance from the current position to other uncompleted work orders based on the distance matrix, combine the distance with the priority score, and evaluate the next target point as shown in the following equation (3):

$$NextScore = γ \times Score - δ \times Travel Distance \qquad ( 3 )$$

Wherein, γ and δ are weight coefficients used to balance the influence of priority order and distance. Next, an initial route is generated using a heuristic algorithm (such as the nearest neighbor algorithm or the greedy algorithm), and the weight coefficients γ and δ are calculated in the same way as α and β as described above.

The route data generated and output by the route planning module 13 may include a list of work route and a corresponding visual route graph, and may include recommended maintenance routes, including the repair sequence, estimated arrival time and completion time of each work order.

The information preprocessing module 14 can use the GPS coordinate of the vehicle for maintenance to filter abnormal data points (such as drift points) for GPS data preprocessing and anomaly filtering, so as to ensure the accuracy and stability of the data. For example, to calculate whether two GPS coordinate data points are within a reasonable distance, the distance formula, Δx=Δt×v, can be used to obtain the speed v (m/s), wherein Δx represents the distance between the two points, and Δt represents the time interval. For instance, for a vehicle used for maintenance with a speed of 110 km/h, the abnormal data threshold (max_speed_threshold) is approximately 30.56 m/s. If the speed v is greater than 0 and less than 30.56 m/s, it indicates that the speed is a reasonable value, and the data at that location point should be recorded.

The calculation module 12 can also be used for speed and time calculations. Specifically, based on the location (GPS) and corresponding timestamp of the vehicle used for maintenance obtained from the information preprocessing module 14, the real-time speed and average speed of the vehicle used for maintenance along the route between work locations can be calculated. Then, the work start time and end time can be used to calculate the total travel time (total travel time).

The location determination module 15 automatically identifies the start point and the end point of movement of the vehicle during the work schedule, that is, the detection of the start and end points of the work schedule. When the latest location of the vehicle moves away from the range (such as the work start position (worker_start_position)) by a distance exceeding the start point radius (start_point_radius) of 200 meters, and the speed exceeds 50 kilometers per hour, the geographical information can be set as the start point of movement; When a vehicle's latest location enters the range (such as the work start position) within a 50-meter end-point radius, and the time interval from the previous point exceeds one hour and the end-point speed does not exceed 20 kilometers per hour, it is considered to have returned to the origin. This geographic information can then be set as the end point of movement.

When the status of a work order changes or a new work order is detected, for example, when the data loading module 11 is input with the data of a new work order, the calculation module 12 can recalculate the priority score of all work orders based on the new work data, and the route planning module 13 can re-evaluate the next score of the target point to ensure that the next work order currently selected is still optimal, so as to update and generate new route data in real time and adjust the route of the work schedule in real time. Specifically, when the next score (Next Score) changes, the candidate list of work order is reordered, a new target point is selected, and the route is dynamically updated. The triggering conditions and execution timing for instantly adjusting the travel path are shown in the following TABLE III:

TABLE III

| Triggering conditions | Execution |
|---|---|
| Adding new work order | Recalculating the score (Score), |
| | adjusting the next score (Next Score), |
| | and update the target point |
| Current work order | Removing completed work order and |
| completed | select optimized the next work order |

Through the above-mentioned operations, including loading work data (initialization), establishing distance matrix and priority matrix (calculation), calculating the priority score of each work order based on the weight model (modeling), generating the best route including a work route list and a visualized route graph (such as using Google Maps API) (route result output), filtering abnormal geographical information (real-time information preprocessing), and detecting whether the vehicle has left the start point and whether it has returned to the origin (start and end point detection), a complete maintenance route can be generated (trip result output). The output of the work schedule may include recommended maintenance routes (such as sequence: work order 1→work order 2→work order 3→ . . . ), the completion time (estimated completion time) of each work order, a visualization map, and a route map (marking the work location of each work order and the movement route between work locations).

The following illustrates an example of work order priority score ranking. Assume there are 4 maintenance work orders on the same day, as shown in the TABLE IV below. The system calculates the priority score based on priority and remaining repair time.

TABLE IV

| ID of | | |
|---|---|---|
| work | | |
| order | Priority | Remaining repair time (hour) |
| 001 | 5 | 2 |
| 002 | 4 | 1 |
| 003 | 3 | 1.5 |
| 004 | 2 | 0.5 |

The calculation formula is: Score=α×Priority-β×Repair Time. Then setting α≈1.37 (weight of priority) and β=1.68 (weight of remaining time), the calculated priority score is shown in the TABLE V below:

TABLE V

| ID of | | |
|---|---|---|
| work | | Priority score |
| order | Score calculation | (Score) |
| 001 | 1.37 × 5 − 1.68 × 2 | 3.5 |
| 002 | 1.37 × 4 − 1.68 × 1 | 3.8 |
| 003 | 1.37 × 3 − 1.68 × 1.5 | 1.6 |
| 004 | 1.37 × 2 − 1.68 × 0.5 | 2.0 |

According to the TABLE V above, the system selects work order 002 as the first target point based on the priority score.

The describes following an example of establishing a preliminary route. The start point of vehicle A used by the staff for maintenance is set as the company. Based on the priority score mentioned above, work order 002 is selected as the first target point, and the distance from work order 002 to the work locations of other work orders is calculated as shown in TABLE VI below:

TABLE VI

| Target | | | |
|---|---|---|---|
| work order | Longitude | Latitude | Distance (km) |
| 001 | 121.570 | 25.040 | 3.2 |
| 003 | 121.580 | 25.050 | 4.5 |
| 004 | 121.590 | 25.060 | 6.8 |

Next, based on TABLE VI and Equation (3): Next Score=γ×Score−δ×Travel Distance, the next target point is evaluated, and γ=1 (weight of priority score) and δ=0.1 (weight of distance) are set to obtain the following TABLE VII:

TABLE VII

| ID of work | | | |
|---|---|---|---|
| order | Score | Distance (km) | Next Score |
| 001 | 3.5 | 3.2 | 3.18 |
| 003 | 1.6 | 4.5 | 1.15 |
| 004 | 2.0 | 6.8 | 1.32 |

Then, select the next work order based on the calculated Next Score, and calculate the next work order. Repeat the above steps in sequence until all work orders are completed. The preliminary route after calculation can be obtained: Company→Work Order 002, Work Order 002→Work Order 001, Work Order 001→Work Order 004, Work Order 004→Work Order 003, Work Order 003→Company.

When the system detects the insertion of a new work order, it can recalculate the priority score in a timely manner according to the above operations and dynamically adjust the target point to adjust the route in real time.

The following describes an example of route start detection. The time is 07:30 AM, and the vehicle A used for maintenance is located at the company. When the GPS detects that the vehicle A used for maintenance has left the company, the distance it has moved exceeds the start point radius (start_point_radius) of 200 meters, and the speed it has moved exceeds the start point speed (start_point_speed) of 50 km/h, the system determines that the route has started and records the start time and location.

The following illustrates an example of route planning and anomaly data processing. The GPS records of vehicle A, used for maintenance, during its route are shown in the TABLE VIII below:

TABLE VIII

| Time | Longitude | Latitude | Speed(m/s) |
|---|---|---|---|
| 07:40 | 121.570 | 25.040 | 15.0 |
| 07:45 | 121.580 | 25.050 | 120.0 (abnormal) |
| 07:50 | 121.590 | 25.060 | 20.0 |

As can be seen in TABLE VIII, the recording speed at 07:45 is 120.0 m/s, which is higher than the abnormal data threshold (max_speed_threshold) of 30.56 m/s. Therefore, the system judges the recording point as abnormal and automatically filters the recording point to avoid affecting the route analysis.

The following describes an example of route end detection. The time is 05:30 PM, and vehicle A, used for maintenance, is returning to the company. When the GPS detects that vehicle A, used for maintenance, has entered the end point radius (end_point_radius) of 50 m, and the time interval from the previous point exceeds 1 hour, and the moving speed exceeds the start point speed (start_point_speed) of 50 km/h and is lower than the end point speed (end_point_speed) of 20 km/h, the system determines that the route has ended and records the end time and end position.

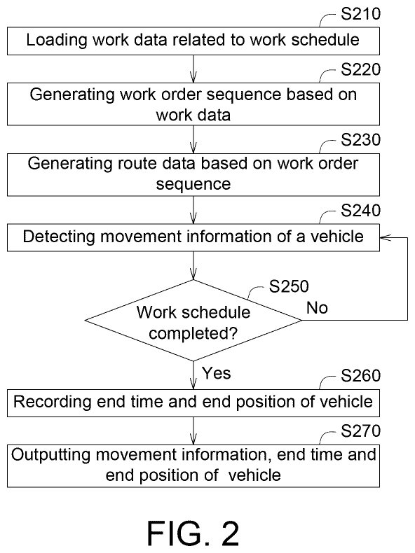

FIG. 2 is a flowchart illustrating procedure for scheduling work according schedule, to some implementations of the present application. In step S210, the data loading module 11 loads work data related to the work schedule. In step S220, the calculation module 12 generates a work order sequence based on the work data. In step s230, the route planning module 13 generates route data based on the work order sequence. In step S240, the information preprocessing module 14 detects a movement information of a vehicle. In step S250, the location determination module 15 determines whether the work schedule is completed. If it is determined that the work schedule has not been completed, returns to step S240, and the information preprocessing module 14 continues to detect the movement information of the vehicle. If it is determined in step S250 that the work trip has been completed, then proceed to step S260, where the output module 16 records the end time and the end position, and proceed to step S270, where the output module 16 outputs the movement information, the end time and the end position of the vehicle.

In certain configurations, the work data includes multiple work orders, and a work location, a priority, and a remaining repair time of each work order. Generating the work order sequence based on the work data includes: sing a weighted model to calculate a priority score for each work order based on the priority and the remaining repair time of each work order; and generating the work order sequence based on priority scores of the work orders.

In certain configurations, generating the route data based on the work order sequence includes: selecting the work location of a work order with a highest priority score among the work orders as a first target point, based on the work order sequence; calculating multiple next target points sequentially, according to a distance between a current position and the work location of each of uncompleted work orders among the work orders, and the priority score of each of the uncompleted work orders among the work orders; and generating the route data based on the first target point and the multiple next target points.

In certain configurations, the route data includes a work route list and a visual route graph. The work route list includes a repair sequence, an estimated arrival time and a completion time of each work order.

In certain configurations, when a new work order is added to the work data, updates the work schedule and correspondingly generates an updated work order sequence, and the route planning module generates updated route data.

In certain configurations, detecting the movement information of the vehicle includes: recording a timestamp of the vehicle arriving at the work location of each work order based on a GPS coordinate in the movement information of the vehicle and the work location of each work order; calculating an actual speed and an average speed of the vehicle between the work location of each work order based on the timestamp and the route data; filtering out an abnormal data point based on the GPS coordinate, wherein the actual speed corresponding to the abnormal data point is greater than a speed threshold; and calculating a travel time of the work schedule based on the timestamp of the vehicle arriving at the work location of each of the plurality of work orders and the route data.

In addition, the present disclosure also reveals a non-volatile computer-readable storage medium, which is applied to a computing device or computer having a processor (e.g., CPU, GPU, etc.) and/or memory, and stores instructions. The computing device or execute computer can the non-volatile computer-readable storage medium through the processor and/or memory to perform the above-mentioned methods and steps when executing the non-volatile computer-readable storage medium. In one embodiment, the present disclosure reveals a non-transitory computer-readable storage medium for performing the above-mentioned methods and steps.

Accordingly, as described above, the techniques provided by the present invention plans the optimal maintenance route data by combining work schedules and work order sequence, and uses geographic information to dynamically detect the start/end point and abnormal data points, thereby optimizing work scheduling and work movement time. At the same time, through the output of results, the transparency and management efficiency of work scheduling execution are enhanced, providing users with an efficient and accurate maintenance route planning solution.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A system for scheduling work schedule, comprising:
a data loading module, configured to load work data related to the work schedule;
a calculation module, communicatively coupled to the data loading module to generate a work order sequence based on the work data;
a route planning module, communicatively coupled to the calculation module to generate route data based on the work order sequence;
a location determination module, communicatively coupled to the route planning module to determine whether the work schedule is completed based on a movement information of a vehicle and the route data, wherein if it is determined that the work schedule has been completed, an end time and an end position of the vehicle are recorded; or if it is determined that the work schedule is not completed, continues to determine whether the work schedule is completed based on the movement information and the route data; and
an output module, communicatively coupled to the location determination module to output the movement information, the end time and the end position of the vehicle.

2. The system for scheduling work schedule of claim 1, further comprising an information preprocessing module, coupled to the calculation module and the location determination module, and configured to detect the movement information of the vehicle and filter out an abnormal data point based on a GPS coordinate in the movement information of the vehicle,
wherein an actual speed corresponding to the abnormal data point is greater than a speed threshold.

3. The system for scheduling work schedule of claim 2, wherein the work data comprises a plurality of work orders, and a work location, a priority, and a remaining repair time of each of the plurality of work orders,
wherein, the calculation module uses a weighted model to calculate a priority score for each of the plurality of work orders based on the priority and the remaining repair time of each of the plurality of work orders, and generates the work order sequence based on priority scores of the plurality of work orders.

4. The system for scheduling work schedule of claim 3, wherein the route planning module is configured to:
select the work location of a work order with a highest priority score among the plurality of work orders as a first target point, based on the work order sequence;
calculate a plurality of next target points sequentially, according to a distance between a current position and the work location of each of uncompleted work orders among the plurality of work orders, and the priority score of each of the uncompleted work orders among the plurality of work orders; and
generate the route data based on the first target point and the plurality of next target points.

5. The system for scheduling work schedule of claim 4, wherein the route data generated by the route planning module includes a work route list and a visual route graph,
wherein the work route list includes a repair sequence, an estimated arrival time and a completion time of each of the plurality of work orders.

6. The system for scheduling work schedule of claim 4, wherein, when a new work order is added to the work data, the data loading module updates the work schedule, the calculation module generates an updated work order sequence, and the route planning module generates updated route data.

7. The system for scheduling work schedule of claim 4, wherein the location determination module records a timestamp of the vehicle arriving at the work location of each of the plurality of work orders based on the GPS coordinate in the movement information of the vehicle and the work location of each of the plurality of work orders,
wherein the calculation module calculates the actual speed and an average speed of the vehicle between the work location of each of the plurality of work orders based on the timestamp and the route data,
wherein the calculation module calculates a travel time of the work schedule based on the timestamp of the vehicle arriving at the work location of each of the plurality of work orders and the route data.

8. A method for scheduling work schedule, executed by a computing device, the method comprising:
loading work data related to the work schedule;
generating a work order sequence based on the work data;
generating route data based on the work order sequence;
detecting a movement information of a vehicle;
determining whether the work schedule is completed based on the movement information and the route data, wherein if it is determined that the work schedule has been completed, an end time and an end position of the vehicle are recorded; or if it is determined that the work schedule is not completed, continues to determine whether the work schedule is completed based on the movement information and the route data; and
outputting the movement information, the end time and the end position of the vehicle.

9. The method for scheduling work schedule of claim 8, wherein the work data comprises a plurality of work orders, and a work location, a priority, and a remaining repair time of each of the plurality of work orders,
wherein generating the work order sequence based on the work data comprises:
using a weighted model to calculate a priority score for each of the plurality of work orders based on the priority and the remaining repair time of each of the plurality of work orders; and
generating the work order sequence based on priority scores of the plurality of work orders.

10. The method for scheduling work schedule of claim 9, wherein generating the route data based on the work order sequence comprises:
selecting the work location of a work order with a highest priority score among the plurality of work orders as a first target point, based on the work order sequence;
calculating a plurality of next target points sequentially, according to a distance between a current position and the work location of each of uncompleted work orders among the plurality of work orders, and the priority score of each of the uncompleted work orders among the plurality of work orders; and
generating the route data based on the first target point and the plurality of next target points.

11. The method for scheduling work schedule of claim 10, wherein the route data includes a work route list and a visual route graph,
wherein the work route list includes a repair sequence, an estimated arrival time and a completion time of each of the plurality of work orders.

12. The method for scheduling work schedule of claim 9, wherein, when a new work order is added to the work data, updating the work schedule and correspondingly generating an updated work order sequence, and generating updated route data.

13. The method for scheduling work schedule of claim 10, wherein detecting the movement information of the vehicle comprises:
recording a timestamp of the vehicle arriving at the work location of each of the plurality of work orders based on a GPS coordinate in the movement information of the vehicle and the work location of each of the plurality of work orders;
calculating an actual speed and an average speed of the vehicle between the work location of each of the plurality of work orders based on the timestamp and the route data;
filtering out an abnormal data point based on the GPS coordinate, wherein the actual speed corresponding to the abnormal data point is greater than a speed threshold; and
calculating a travel time of the work schedule based on the timestamp of the vehicle arriving at the work location of each of the plurality of work orders and the route data.

14. A non-volatile computer-readable storage medium, applied to a computing device or a computer, storing instructions for executing the method for scheduling work schedule according to claim 8.
